(19) United States
(12) Patent Application Publication
(10) Pub. No.: US 2006/0193620 A1
(43) Pub. Date: Aug. 31, 2006

(54) Lorentz actuator for miniature camera

(76) Inventors: Darrell Harrington, Pasadena, CA (US); Guiqin Wang, Arcadia, CA (US); Roman C. Gutierrez, Arcadia, CA (US); Robert J. Calvet, Pasadena, CA (US)

Correspondence Address: MACPHERSON KWOK CHEN & HEID LLP, 1762 TECHNOLOGY DRIVE, SUITE 226, SAN JOSE, CA, 95110, US

(21) Appl. No.: 11/263,149

(22) Filed: Oct. 31, 2005

Related U.S. Application Data
(60) Provisional application No. 60/657,261, filed on Feb. 28, 2005.

(51) Int. Cl. G03B 3/10

(52) U.S. Cl. 396/85; 396/133

(57) ABSTRACT

An actuator for miniature cameras and the like is disclosed. The actuator can comprise a plurality of magnets and a plurality of coils disposed generally symmetrically with respect to the magnets. The magnets and the coils are configured so that they cooperate in order to effect substantially linear movement due to a Lorentz force therebetween. In this manner, undesirable rotational forces can be substantially mitigated. The actuator can be used to effect movement of optical elements to facilitate variable focus, zoom, and/or image stabilization, for example.

### PRIORITY CLAIM

This patent application claims the benefit of the priority date of U.S. provisional patent application Ser. No. 60/657,261, filed on Feb. 13, 2005 and entitled AUTOFOCUS CAMERA (docket no. M-15826-V1 US) pursuant to 35 USC 119. The entire contents of this provisional patent application are hereby expressly incorporated by reference.

### TECHNICAL FIELD

The present invention relates generally to electric motors, particularly linear motors, i.e., actuators. The present invention relates even more particularly to a Lorentz actuator for moving optical elements of a miniature camera, such as a miniature camera configured for use in a cellular telephone.

### BACKGROUND

Miniature cameras are well known. Miniature cameras are widely used in contemporary cellular telephones. They are also used in other devices, such as laptop computers and personal digital assistants (PDA). Miniature cameras can even be used as stand alone devices for such applications as security and surveillance.

Contemporary miniature cameras, such as those used in cellular telephones, are fixed focus cameras. That is, the focus of the cameras is preset. The camera has a small enough aperture so as to provide sufficient depth of field such that focus is generally acceptable over a wide range of distances. However, such stopping down of the camera severely limits it's use in low light conditions.

In an attempt to enhance the use of such fixed focus cameras in low light conditions, a flash has been added. However, the use of a flash tends to more rapidly drain the batteries, thus requiring more frequent charging. Generally, more frequent charging of the batteries is undesirable.

Further, the use of variable focus tends to improve low light performance by not requiring that the aperture be stopped down and also tends to provide higher quality images by facilitating better focusing. Providing a camera with variable focus also facilitates the use of autofocus, which may further enhance a user's ability to make higher quality images.

Contemporary miniature cameras also lack desirable zoom and image stabilization features. Such features yet further enhance a user's ability to make higher quality images. As those skilled in the art will appreciate, an optical zoom feature allows a user to magnify an image without relying upon the use of digital zoom which substantially degrades an image, especially at higher magnifications. Further, image stabilization substantially enhances the quality of an image by mitigating blurring due to small, inadvertent movements of the camera as an exposure is being made.

However, in order to move the optical elements, such as the lenses associated with variable focus, zoom, and/or image stabilization, it is necessary to use actuators. Of course, such actuators must small enough to be suitable for use in a cellular telephone or the like. This is particularly true when a plurality of such actuators must be utilized, such as when they are used to move lenses for both variable focus and zoom or when they are used to move lenses or other elements for image stabilization.

Further, such actuators must be capable of moving the optical elements rapidly and precisely, while also being capable of withstanding the shock and vibration that cellular telephones and the like are routinely subjected to. Further such actuators must be able to withstand repeated cycling, such as that associated with continued use over the lifetime of the cellular telephone.

As such, it is desirable to provide miniature actuators that are suitable for use in variable focus, zoom, and image stabilization mechanisms of cellular telephones and other devices.

### BRIEF SUMMARY

Systems and methods for providing actuators suitable for use in portable electronic devices, such as the cameras of cellular telephones, are disclosed. For example, in accordance with an embodiment of the present invention, an actuator for a miniature camera comprises a plurality of magnets and a plurality of coils disposed generally symmetrically with respect to the magnets. The magnets and the coils can be configured so as to effect linear movement due to a Lorentz force generated therebetween. The magnets and coils can further be configured so that the force generated by the actuator is generally proportional to the current through the coils over the range of travel of the actuator. The magnets and coils are further configured so as to mitigate undesirable non-linear (rotational) movement. Such non-linear movement can result in misalignment of the optical elements.

More particularly, one or more magnets and two or more coils can be used according to one or more embodiments of the present invention. Alternatively, one or more coils and two or more magnets can be so used. Multiple magnets and coils can be configured to enhance the uniformity of magnetic flux through the coils and to maximize the force provided by the actuator, subject to geometric constraints. In either instance, symmetry is provided that tends to mitigate non-linear movement. Regardless of the number of magnets used, two outboard flux guides can optionally be configured so as to minimize a weight thereof while enhancing the strength and uniformity of flux through the coils and while mitigating undesirable fringing magnetic fields of the actuator. Inboard flux guides can also optionally be used. Either one of the magnets or the coils can be configured to move while the other one thereof stays generally stationary, when current flows through the coils.

The use of such an actuator provides sufficient force to move the optical elements of a miniature camera, for example, so as to facilitate such features as variable focus, zoom, and image stabilization. This can be accomplished while maintaining the volume and weight of the camera within acceptable limits.

This invention will be more fully understood in conjunction with the following detailed description taken together with the following drawings.

### BRIEF DESCRIPTION OF THE DRAWINGS

FIG. 1 is a schematic representation of a Lorentz actuator having a single magnet, two coils, and two flux guides (both outboard), and showing the magnetic flux and current flow thereof, according to an embodiment of the present invention;

FIG. 2 is a semi-schematic representation of a Lorentz actuator having three magnets, two coils, and two flux guides (both outboard), and showing the magnetic flux and current flow thereof according to another embodiment of the present invention;

FIG. 3 is semi-schematic representation of a Lorentz actuator having an arbitrary number of magnets, an arbitrary number of coils, and two flux guides (both outboard), according to another embodiment of the present invention;

FIG. 4 is a semi-schematic, perspective view of an optics assembly of a miniature camera having a Lorentz actuator for moving a focusing lens thereof, according to one embodiment of the present invention;

FIG. 5 is a semi-schematic, exploded view of the optics assembly of FIG. 4, showing components of the Lorentz actuator thereof;

FIG. 6 is a semi-schematic, enlarged, perspective view of the lower portion of the optics assembly of FIG. 5, showing the coils of the Lorentz actuator thereof;

FIG. 7 is a semi-schematic, perspective view of the Lorentz actuator of FIG. 5, showing the coils in place relative to the magnets thereof;

FIG. 8 is a semi-schematic, perspective view of the Lorentz actuator of FIG. 7, showing the coils removed therefrom so as to better show the magnet assembly thereof;

FIG. 9 is a semi-schematic, top perspective view of the magnet assembly of FIG. 7, showing the stage removed therefrom;

FIG. 10 is a semi-schematic, top perspective view of the frame of the magnet assembly of FIG. 9;

FIG. 11 is a semi-schematic, perspective view of a coil of the Lorentz actuator of FIG. 5;

FIG. 12 is a semi-schematic, front view of the coil of FIG. 11;

FIG. 13 is a semi-schematic, perspective view of a magnet assembly (which includes the magnet and the flux guide) of the Lorentz actuator of FIG. 5;

FIG. 14 is a semi-schematic, perspective view of a magnet of FIG. 5; and

FIG. 15 is a semi-schematic, perspective view of one magnetic element of the magnet of FIG. 14.

Embodiments of the present invention and their advantages are best understood by referring to the detailed description that follows. It should be appreciated that like reference numerals are used to identify like elements illustrated in one or more of the figures.

### DETAILED DESCRIPTION OF THE INVENTION

A method and system for moving miniature components, such as the optical components of a camera for a cellular telephone, uses the Lorentz force to effect such movement. As those skilled in the art will appreciate, the Lorentz force is a magnetic force that is perpendicular to both the local magnetic field and the direction of motion of a charged particle (an electron). The magnitude of this force is given by the formula:
F=I×B L_{eff}
where:
F is the force,
I is current,
B is the magnetic field strength, and
L_{eff} is the effective length of the conductor that carries the current I within the magnetic field B.

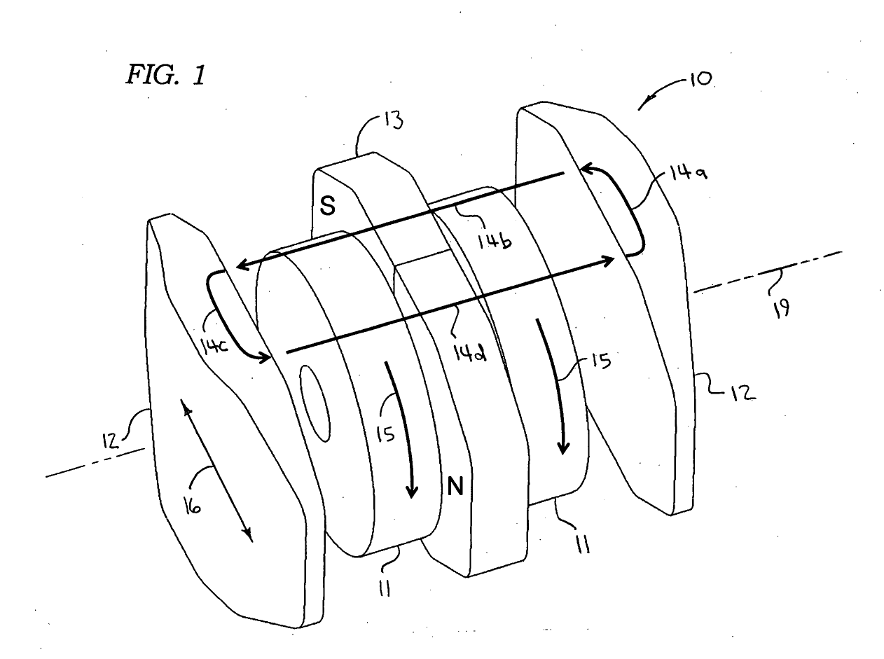

Referring now to FIG. 1, an exemplary embodiment of the present invention is shown. A Lorentz actuator 10 can be defined by a plurality of coils 11 and at least one magnet 13. Optionally, a plurality of flux guides 12 can be included. Two coils 11 can disposed intermediate two outboard flux guides 12. A single magnet 13 can be disposed intermediate coils 11.

Although the actuator is shown as comprising one magnet 13 and two coils 11, the actuator could alternatively comprise one coil 11 and two magnets 13. Indeed, as discussed in further detail below, various combinations of coils 11 and magnets 13 are possible. However, it can be advantageous to maintain a generally symmetric configuration of coils 11 and magnets 13. That is, coils 11 and magnets 13 should generally be symmetric about a plane that is perpendicular to a longitudinal axis 19 of the coil and magnet assembly and that is centered along axis 19. For example, coils 11 and magnets 13 can be generally symmetric about the plane that bisects magnet 13 of FIG. 1 (since magnet 13 is centered along axis 19). Such symmetric configurations tend to mitigate undesirable rotational and off-axis translational forces, as also discussed in further detail below.

Magnet 13 provides a magnetic field having a direction such as that indicated generally by arrows 14a-14d. Thus, magnet 13 is oriented such that it forms a magnetic field whose flux passes substantially through coils 11.

Current, as indicated by arrows 15, can be caused to flow though coils 11 in either direction. Coils 11 are coupled such that current flows in the same direction through both. When current flows though coils 11, a Lorentz force results between coils 11 and magnet 13. If coils 11 are fixed in position (such as by attachment to a frame or enclosure) and magnet 13 is free to move, then coils 11 will tend to remain comparatively stationary while magnet 13 moves as indicted by arrow 16. The direction of the motion of magnet 13 is dependent upon the direction of current flow within coils 11, which is controllable. Thus, magnet 13 and any structures attached thereto (such as a stage and/or optical elements) will move in response to a current drive signal applied to coils 11.

Magnets 13 can alternatively be fixed in position and coils 11 can be free to move, such that current flow through coils 11 tends to cause coils 11 to move. In either instance, movable components, such as optical elements, can be attached or otherwise coupled to the moving elements (either magnets 13 or coils 11) so as to effect desired positioning of the movable components.

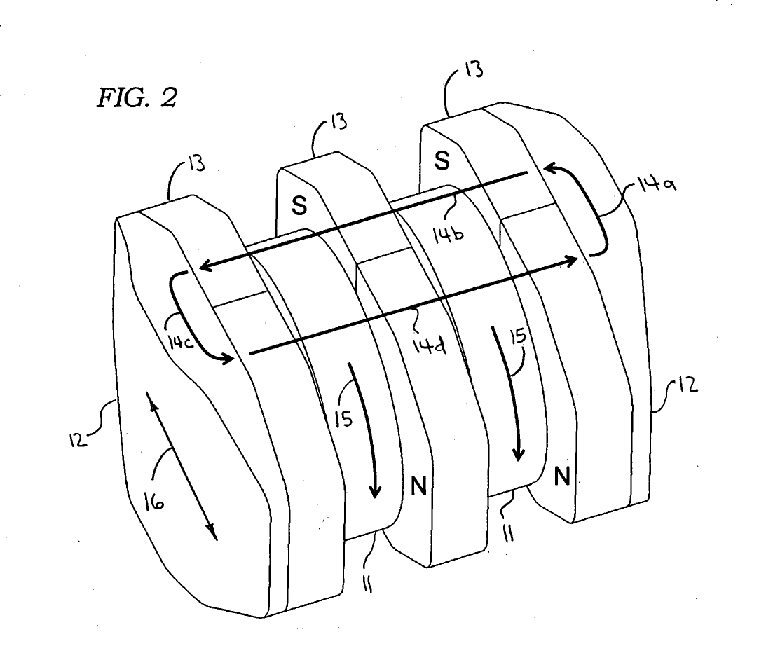

Referring now to FIG. 2, two additional magnets 13 can be added in outboard positions, such as adjacent flux guides 12. Additional magnets 13 increase the flux flow through coils 11 and thus enhance the power and efficiency of the Lorentz actuator.

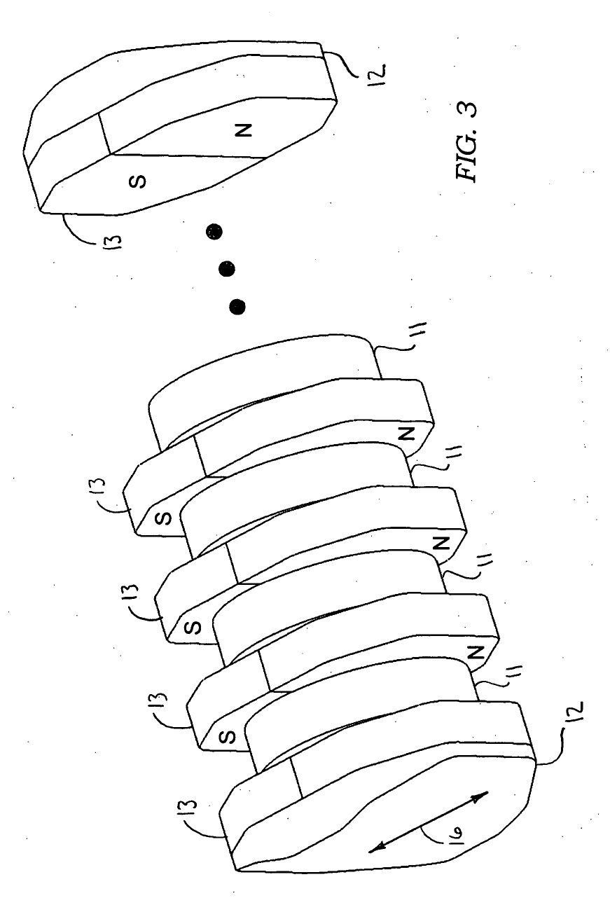

Referring now to FIG. 3, any desired number of coils 11 and magnets 13 can be used, as indicated by the ellipsis. Typically, coils 11 and magnets 13 will be configured in an alternating fashion. There can be one more coil 11 than the number of magnets 13 (as shown in FIG. 1) or one more magnet 13 than the number of coils 11 (as shown in FIGS. 2 and 3). This unequal number of coils 11 and magnets 13 can be used to obtain symmetry (as shown in FIGS. 1-3).

However, the configuration of the magnets 13 and the coils does not have to be alternating and the number of coils 11 can relate to the number of magnets 13 in any other manner. Indeed, symmetry can be obtained with an equal number of coils 11 and magnets 13 or with a great disparity between the number of coils 11 and magnets 13. For example, symmetry can be obtained by positioning two coils 11 together (side-by side or adjacent one another in the center) and by placing two magnets 13 outboard thereof—one on either side of coils 11. As a further example, symmetry could be obtained by positioning four coils 11 together (side-by-side at the center) and by placing three magnets on each side thereof (for a total of six magnets 13). Thus two or more coils 11 can be placed side-by-side with no intervening magnets 13 and two or more magnets 13 can be placed side-by-side with no intervening coils 11. Thus, those skilled in the art will appreciate that many different symmetric configurations of coils 11 and magnets 13 are possible.

With any configuration of coils 11 and magnets 13, flux guides 12 can optionally be added. Typically, flux guides 12 will be outboard of the outermost magnets 12 or coils 11. However, flux guides 12 can be at any other desired location that tends to enhance flux through coils 11. Further, the flux guides 12 can have any desired shape or configuration and thus do not have to be configured as shown in the figures.

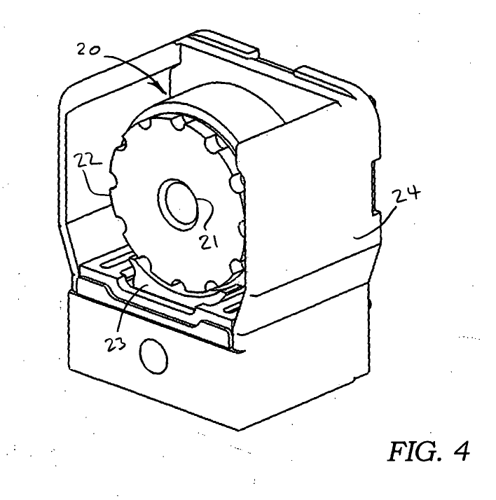

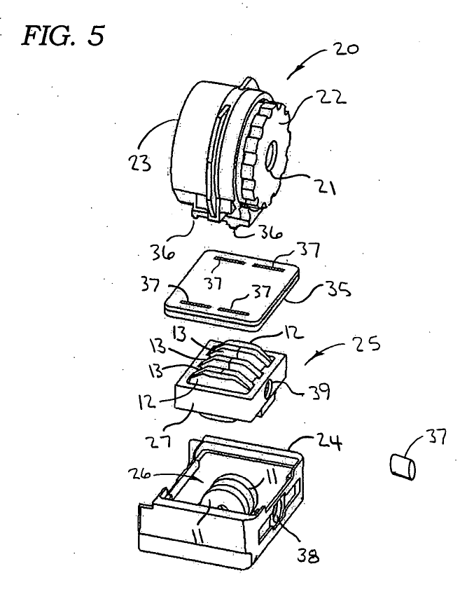

Referring now to FIGS. 4 and 5, an actuator formed according to one embodiment of the present invention can be used to move elements of a miniature camera optics assembly 20. Optics assembly 20 can comprise, for example, a focusing lens 21 that is held by a lens barrel 22. Lens barrel 22 is attached, such as via threads, to a lens mount 23. Lens mount 23 can be caused to move linearly by a Lorentz actuator of the present invention. A housing 24 can generally surround the components of optical assembly 20. Focusing lens 21 can focus an image upon an imaging sensor (not shown).

Alternatively, optics assembly 20 can comprise a zoom lens, image stabilization elements, or any desired combination of focusing lens, zoom lens, image stabilization element and/or other optical elements. For example, a Lorentz actuator of the present invention can be used to move the blade or blades or a shutter or iris. One or more actuators can be used to move any combination of such lenses and/or other elements, as desired.

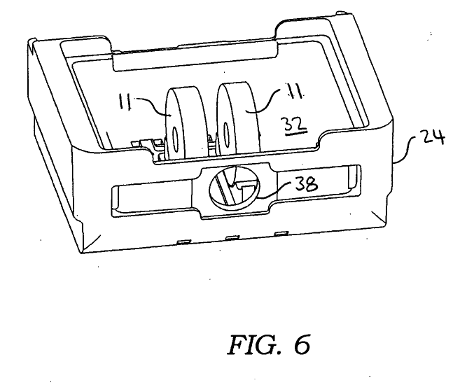

The actuator comprises a magnet assembly and a coil assembly 26. Magnet assembly 25 comprises a frame 27 that holds magnets 13 (which as shown in FIG. 5 include one central magnet and two outboard magnets in the configuration of FIG. 2) and any flux guides 12 in place with respect to one another. Coil assembly 26 can comprise two coils 11 (best shown in FIGS. 6, 11, and 12).

Magnet assembly 25 can be attached to a stage 35 such that movement of magnet assembly 25 results in like movement of stage 35. Stage 35 is attached to lens mount 23. For example, feet 36 of lens mount 23 can be received within openings 37 of stage 35. Feet 36 can be adhesively bonded, ultrasonically welded, or otherwise permanently attached to stage 35. Thus, linear movement of magnet assembly 25 results in linear movement of lens 21, such as to effect focusing of a miniature camera.

Optionally, a biasing spring 37 can be inserted through spring aperture 38 and placed into contact with spring seat 39 so as to bias magnet assembly 25 (and consequently lens 21) toward one end of housing 24. Biasing lens 21 toward one end of housing 24 such that it moves to a known position when current is not flowing through coils 11 can advantageously be used to provide a known location of lens 21 on power up and also to provide a comparatively stable position of stage 35 that enhances resistance to mechanical shock. For example, lens 21 can be biased by spring 37 into either the infinity focus or closest focus position thereof.

Thus, lens 21 can be biased by spring 37 so as to effectively provide focus at infinity when no current flows through coils 11. Such biasing generally tends to minimize the travel required by lens 21 to effect focus, on average. It also provides a more desirable failure mode with respect to optics assembly 20, since a failure is thus more likely to result in lens 20 becoming fixed at infinity focus, where it is more likely to be most useful. That is, if the Lorentz actuator fails, then lens 20 will remain in the infinity focus position due to spring 37, and will thus tend to remain useful.

Referring now to FIG. 6, coils 11 can be mounted to a floor 32 of housing 24. Thus, coils 11 are fixed in position with respect to housing 24 such that it is magnet assembly 25 that moves in response to current flow through coils 11.

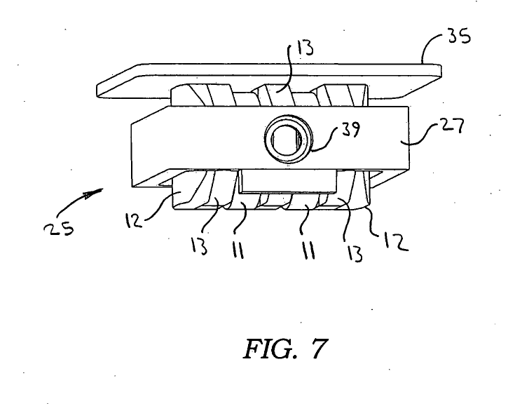

Referring now to FIG. 7, magnet assembly 25 and stage 35 are shown with coils 11 in place with respect thereto. Again, since coils 11 are attached to housing 24 (shown in FIG. 6), it is magnet assembly 25 (and consequently stage 35, as well as lens 21 attached thereto) that moves when current flows through coils 11.

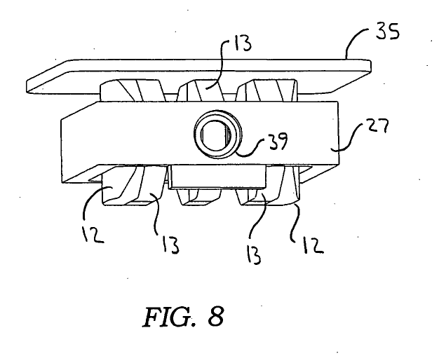

Referring now to FIG. 8, coils 11 are shown removed from the assembly of FIG. 7 to better show the magnets 13 thereof. Flux guides 12 tend to make the magnetic field formed by magnets 13 more uniform, especially proximate coils 11. Flux guides 12 also tend to mitigate undesirable fringe effects whereby outer portions of the magnetic field do not contribute to the Lorentz force that effects movement of lens 21. That is, flux guides 12 tend to concentrate the flux in the space occupied by coils 11, so as to enhance the magnetic field's effectiveness for use in causing motion in response to current flow in coils 11. The use of multiple coils 11 and magnets 13 also tends to mitigate undesirable fringe effects and concentrate the flux in the space occupied by coils 11.

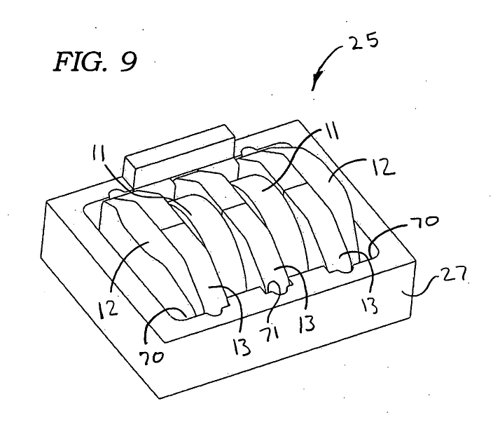

Referring now to FIG. 9, magnet assembly 25 is shown with coils 11 in place and with stage 35 removed therefrom. The relative positioning of coils 11 with respect to magnets 13 can be seen. Further, outboard slots 70 and inboard slots 71 are configured so as to hold magnets 13 in the desired relative positions. As those skilled in the art will appreciate, outboard magnets 13 are oriented such that they attract one another. Outboard 70 and inboard 71 slots help prevent magnets 13 from moving undesirably towards one another due to such repulsion. Optionally or additionally, magnets 13 can be adhesively bonded or otherwise held in place. Any combination of slots and other means for holding magnets 13 in place can be used.

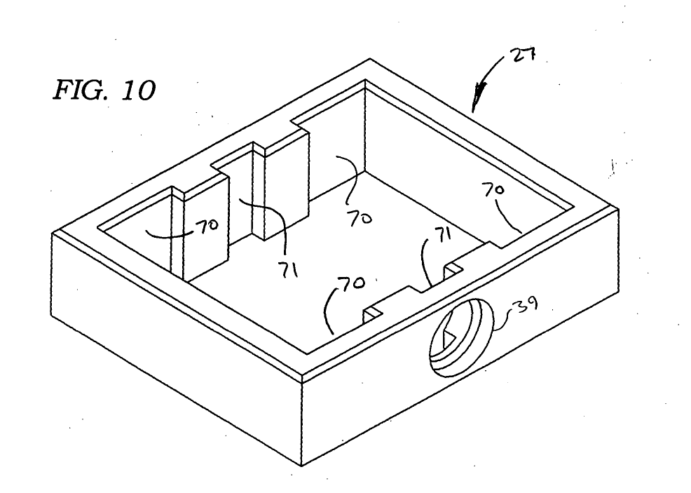

Referring now to FIG. 10, frame 27 of magnet assembly 25 is shown with magnets 13 and flux guides 12 removed therefrom. Frame 27 can be formed of various non-ferrous materials such a plastic or aluminum. The use of a non-ferrous material helps to maintain the magnetic field proximate the magnets 13, where it is more effective in producing the desired Lorentz force upon coils 11 when current flows through coils 11.

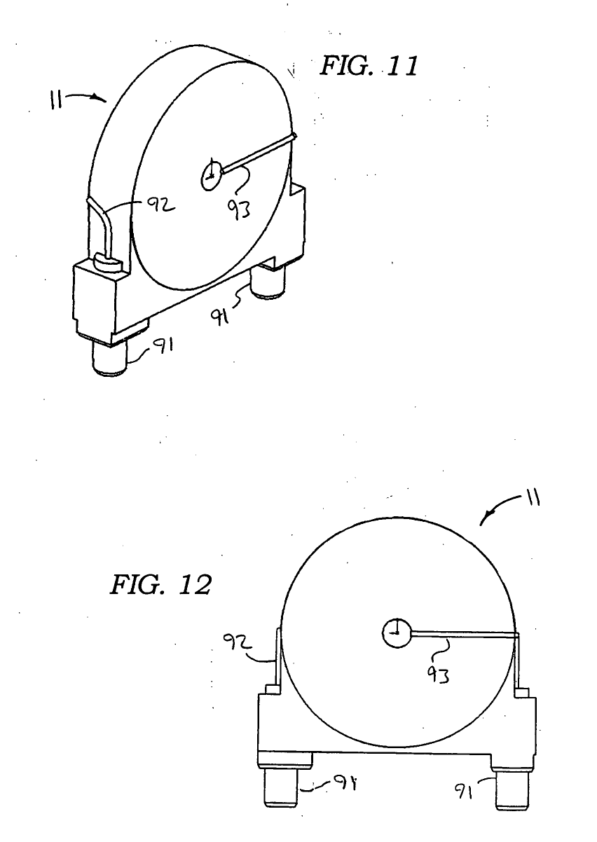

Referring now to FIGS. 11 and 12, each coil 11 can comprise two feet 91 that are used both to mount each coil 91 to floor 32 of housing 24 and to provide electrical connection to coils 11. Thus, feet 91 can be used to mount coils 11 by inserting feet 91 into complementary holes in floor 32 of housing 24 (as shown in FIG. 6). Leads 92 and 93 provide electrical communication between feet 91 and the windings of coils 11.

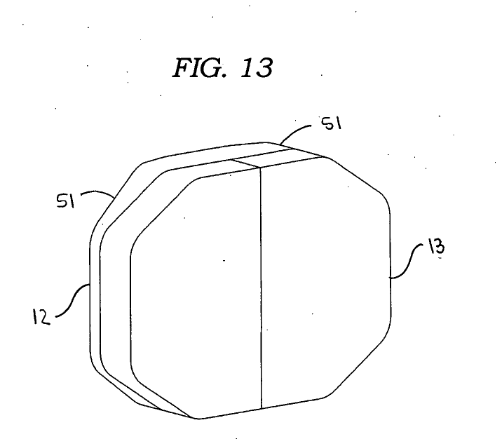

Referring now to FIG. 13, each outboard flux guide 12 can comprise a single plate formed of a ferrous material. Outboard flux guides 12 tend to concentrate the flux of the magnetic field (FIGS. 1 and 2) where it more effectively facilitates the generation of a Lorentz force due to current flow in coils 11. The weight of outboard flux guides 12 is mitigated by forming chamfers 51 thereon. Chamfers 51 are advantageously formed such that they tend to have minimal adverse impact upon each flux guide's ability to concentrate flux though coils 11. Thus, the flux through coils 11 is enhanced while mitigating the weight of magnet assembly 25. The outboard flux guides 12 and any optional inboard flux guide(s) can be formed of a ferrous material with high saturation, such as cold rolled steel.

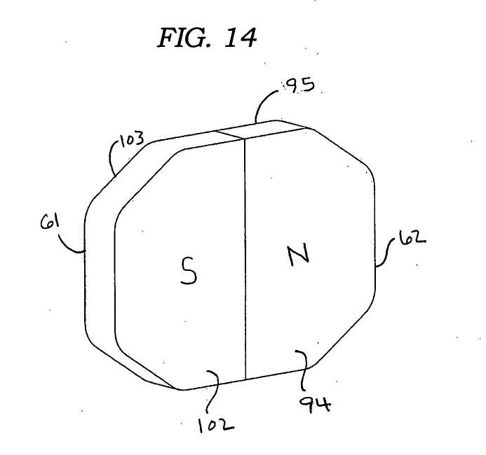

Referring now to FIG. 14, magnets 13 can be formed of two separate magnetic elements, 61 and 62, with the poles thereof oriented such that a generally continuous loop of magnetic flux is formed through coils 11 by magnetic assembly 25. For example, magnetic element 61 can be formed such that a south pole is defined on one face 102 thereof and a north pole is defined on the opposite face 103 thereof. Similarly, magnetic element 62 can be formed such that a north pole is defined on one face 94 and a south pole is defined on the opposite face 95 thereof.

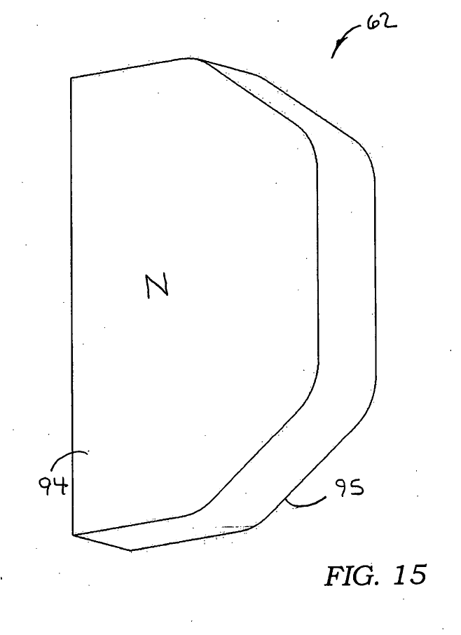

Referring now to FIG. 15, a single magnetic element 62 (which is itself a magnet) is shown with the complimentary magnetic element 61 removed therefrom. Each magnet 13 can be formed of two such complimentary magnetic elements 61, 62. Each magnetic element 61 can optionally be adhesively bonded or otherwise attached to its complimentary magnetic element 62 to form a complete magnet 13, as shown in FIG. 14. Each magnetic element 61, 62 can comprise a NdFeB magnet. Alternatively, each magnet 13 can be formed from a single element that is half polarized in one direction and half polarized in the opposite direction, so that the magnetic field configuration is substantially similar to a magnet 13 formed from two magnetic elements 61 and 62.

The configuration of magnets 13 and coils 11 shown in FIGS. 5-15 tends to provide minimal gap distance between magnets 13, efficient routing of flux from magnets 13 through coils 11, optimal thickness of magnets 13 considering weight and volume versus force tradeoffs, optimal thickness of coils 11 considering weight and volume versus force tradeoffs, optimal magnet 13 thickness versus coil 11 thickness, optimal overall size and weight versus force tradeoffs, and optimal coil 11 radius considering uniformity of the ratio of force to current along the actuator's range of travel. Compared to Lorentz actuators of similar volume, but having only a single coil, Lorentz actuators of the present invention that have a plurality of coils provide more force for a given amount of current, more force for a given input power, and better uniformity of the force to current ratio over the actuator's travel.

Further, the configuration of coils 11 and magnets 13—more particularly the symmetric and spaced apart configuration thereof—substantially inhibits undesirable torquing of stage 35 (and consequently of lens 21). That is, both outboard magnets 13 tend to experience substantially the same force thereon such that linear movement of stage 35 results from current flow through coils 11 and such that resulting rotational and off-axis translational forces tend to be mitigated. Thus, as compared to other possible configurations of Lorentz actuators, such as those having only a single coil and a single magnet and other asymmetrical configurations, Lorentz actuators of the present invention provide more linear movement of the moving element and are less likely to bind or wear undesirably.

Any desired number of magnets and coils may be used, as long as there is effectively a plurality of at least one (either magnets or coils) thereof, so as to facilitate symmetrical configuration and thereby inhibit the undesirable application of torque to a structure driven by the actuator. Configuring the Lorentz actuator of the present invention such that two coils and three magnets are used, as shown in the exemplary embodiment of FIG. 2, provides a lightweight and volume efficient actuator that can generate a comparatively enhanced amount of force for a device of its size, while mitigating the generation of undesirable torque due to its symmetric construction (which is based upon the use of plural coils and magnets).

Embodiments described above illustrate, but do not limit, the invention. It should also be understood that numerous modifications and variations are possible in accordance with the principles of the present invention. Accordingly, the scope of the invention is defined only by the following claims.

1. An actuator for a miniature camera, the actuator comprising:
at least one magnet;
at least one coil; and
wherein the magnet(s) and the coil(s) are configured symmetrically with respect to one another, so as to effect movement due to a Lorentz force therebetween and so as to mitigate a rotational force.

2. The actuator as recited in claim 1, wherein the magnet(s) comprise two magnets.

3. The actuator as recited in claim 1, wherein the magnet(s) comprises three magnets.

4. The actuator as recited in claim 1, wherein the coil(s) comprises two coils.

5. The actuator as recited in claim 1, wherein:
the magnet(s) comprises one magnet; and
the coil(s) comprises two coils, one coil being disposed on either side of the magnet.

6. The actuator as recited in claim 1, wherein:
the magnet(s) comprises three magnets; and the coil(s) comprises two coils disposed in an alternating fashion with respect to the magnets such that each of the coils is disposed intermediate two of the magnets.

7. The actuator as recited in claim 1, further comprising two flux guides, each outboard flux guide disposed proximate an outboard end of one of the magnets.

8. The actuator as recited in claim 1, further comprising two flux guides, each flux guide being disposed outboard of a magnet and being configured so as to minimize a weight thereof while enhancing a magnitude and uniformity of magnetic flux through a dedicated magnet thereof.

9. The actuator as recited in claim 1, further comprising two flux guides, each flux guide being disposed outboard of a magnet and being chamfered so as to minimize a weight thereof while enhancing a uniformity of flux through a magnet and also being configured so as to mitigate undesirable fringe effects of a magnetic field of the actuator.

10. The actuator as recited in claim 1, further comprising two outboard flux guides formed of cold rolled steel.

11. The actuator as recited in claim 1, wherein the magnets comprise NdFeB magnets.

12. The actuator as recited in claim 1, wherein the magnets are configured to move when current flows through the coils.

13. The actuator as recited in claim 1, wherein the coils are configured to move when current flows therethrough.

14. The actuator as recited in claim 1, wherein the coils and magnets are configured to move a linear stage.

15. The actuator as recited in claim 1, wherein the coils and magnets are configured for use in a portable electronic device.

16. The actuator as recited in claim 1, wherein the coils and magnets are configured for use in at least one device selected from the list consisting of:
a camera;
a personal digital assistant (PDA); and
a portable computer.

17. The actuator as recited in claim 1, wherein the coils and magnets are configured for use in a cellular telephone.

18. A miniature camera comprising an actuator, the actuator comprising:
at least one magnet;
at least one coil; and
wherein the magnets and the coils are configured symmetrically.

19. The miniature camera as recited in claim 18, wherein the actuator is configured to facilitate focusing.

20. The miniature camera as recited in claim 18, wherein the actuator is configured to facilitate zooming.

21. The miniature camera as recited in claim 18, wherein the actuator is configured to facilitate image stabilization.

22. A cellular telephone comprising an actuator, the actuator comprising:
at least one magnet;
at least one coil, the coil(s) being disposed generally symmetrically with respect to the magnet(s); and
wherein there is a plurality of either magnets or coils and the magnets and the coils are configured so as to effect movement due to a Lorentz force therebetween.

23. An actuator comprising:
means for defining a magnetic field;
means for conducting charges within the magnetic field, the means for conducting charges being configured generally symmetrically with respect to the means for defining the magnetic field; and
wherein the means for defining a magnetic field and the means for conducting charges are configured so as to effect movement due to a Lorentz force therebetween.

24. A method for making an actuator, the method comprising:
providing a plurality of magnets; and
positioning a plurality of coils generally symmetrically with respect to the magnets such that the magnets and the coils are configured so as to effect movement due to a Lorentz force therebetween.

25. A method for providing image stabilization for a camera, the method comprising using Lorentz force between a magnet and a coil to move an optical element of the camera.

26. An actuator comprising at least one magnet and at least one coil, the magnet(s) comprising two magnetic elements that are configured such that poles thereof are oriented in different directions.

27. The actuator as recited in claim 26, wherein the poles of the two magnetic elements are oriented in two opposite directions.

28. The actuator as recited in claim 26, wherein the two magnetic elements are bonded together.
